(19) United States
(12) Patent Application Publication
(10) Pub. No.: US 2026/0277409 A1
(43) Pub. Date: Sep. 17, 2026

(54) UNIFIED ELEMENT FINDER FOR WEB AND MOBILE

(71) Applicant: FIREFLINK PRIVATE LIMITED, Bangalore, Karnataka (IN)

(72) Inventors: Girish RAMANNA, Bangalore (IN); Jagadeesh H, Bengaluru (IN); Rakesh DR, Bengaluru (IN); Sagar PRADHAN, Bengaluru (IN); Yashaswini H H, Bengaluru (IN)

(73) Assignee: FIREFLINK PRIVATE LIMITED, Bangalore, Karnataka (IN)

(21) Appl. No.: 19/470,678

(22) PCT Filed: Mar. 31, 2024
(86) PCT No.: PCT/IB2024/053138

§ 371 Date: Sep. 29, 2025

(30) Foreign Application Priority Data
Mar. 31, 2023 (IN) 202341024974

(51) Int. Cl. G06F 3/04842

(52) U.S. Cl. CPC G06F 3/04842

(57) ABSTRACT

The present invention discloses a system (100) and a method (600) for locating user interface (UI) elements in a web application and a mobile application using a unified element finder. The system (100) includes a user interface (UI) element finder (202) configured to receive an input from a user (104) to either select a web interface to locate one or more UI elements present in a web application or a mobile interface to locate one or more UI elements in a mobile application. Further, the UI element finder (202) includes an element locating unit (204) and an element recording unit (206). The element locating unit (204) is configured to locate one or more UI elements present on a web application or a mobile application. The element recording unit (206) is configured to record the one or more UI web elements located by the element locating unit (204).

### FIELD OF INVENTION

The present invention generally relates to software testing. More particularly, the invention relates to a system and a method for automatically locating Web and Mobile user interface (UI) elements using a unified element finder.

### BACKGROUND OF INVENTION

With the advancement in the technology, various organisations are adopting test automation techniques to manage vast variety of data within the organisation or between multiple organisations. Test automation is a practice of running various software tests automatically, managing test data automatically, and utilizing results to improve software quality. In other words, test automation is a process of using automation tools to execute a test case suite. A test suite is a collection of test cases or test steps grouped together for text execution purposes. Therefore, Test Automation is a process to maintain test data, execute tests, and analyze generated test results to improve software quality.

Test Automation may also be referred to as Automated testing or Automated Quality Assurance (QA) testing. When executed well, test automation runs various software tests automatically, thereby eliminating the practise of manual testing performed by a human sitting in front of a computer carefully executing the test steps. Test automation is used by Quality Assurance (QA) engineers in a number of applications, such as testing test scripts, testing web applications, testing mobile applications, creating object repositories, reusing objects stored in object repositories, etc.

To test web applications and mobile applications from an end-user's perspective, QAs have to interact with multiple user interface (UI) web elements and mobile elements. To do so, the QAs use an object repository while writing test automation scripts. An object repository is a common storage location for all objects. QAs store all web element locators located from web applications and mobile element locators located from mobile applications in a separate file, also referred to as a property file (. properties) in Selenium. The property file stores information in a key-value pair format. Maintaining an object repository increases modularity of framework implementation. An object repository enables to reuse user interface (UI) elements across various projects. All the UI web elements and UI mobile elements stored locally in an object repository may be reused at different project levels.

In test automation, building UI web elements and UI mobile elements object repository through manual process is tedious task & requires skilled engineers. Also, hard-coding or manual coding locators or objects in a test script each time results in code duplication. Thus, if a value of any single coding locator or object changes, it needs to be updated throughout the project to ensure consistency, thereby making it a time-consuming task. Further, a separate element finder is required for locating UI web elements in a web application and a separate element finder for locating UI mobile elements in a mobile application. Therefore, maintaining individual element finders for web applications and mobile applications requires huge maintenance.

Therefore, there is a need for a system and a method for building a UI element repository automatically without any human intervention. Also, there is a need for a system and a method for locating UI web elements in a web application and UI mobile elements in a mobile application using a single element finder, thereby eliminating a need for a separate element finder for web applications and separate element finder for mobile applications. There is a need for a system and a method for recording the located UI web elements and located UI mobile elements and allowing a user to use the recorded UI web elements and UI mobile elements in creating test scripts used in software testing.

### OBJECT OF INVENTION

The object of the present invention is to provide a method and a system for locating user interface (UI) elements in a web application and a mobile application using a unified (single) element finder. The object of the present invention is to provide a unified element finder to locate UI web elements in web applications and UI mobile elements in mobile applications with all possible locator values required for Test Automation.

Further, the object of the present invention is to provide a system and a method for recording the located UI web elements and located UI mobile elements and allowing a user to use the recorded UI web elements and UI mobile elements in creating test scripts used in software testing. The object of the present invention is to provide a system and a method for building a UI element repository automatically without any human intervention.

### SUMMARY

The present application discloses a system for locating user interface (UI) elements in a web application and a mobile application using a unified element finder. The system includes a user interface (UI) element finder configured to receive an input from a user to either select a web interface to locate one or more UI elements present in a web application or a mobile interface to locate one or more UI elements present in a mobile application. Further, the UI element finder includes an element locating unit and an element recording unit.

The element locating unit is configured to receive a first input from the user to initiate locating of one or more static UI elements present on a web application or a mobile application based on the selected web interface or mobile interface. Further, the element locating unit is configured to highlight a located static UI element from the located one or more static UI elements. The element locating unit is configured to receive a second input from the user to select the highlighted static UI element.

Further, the element locating unit is configured to receive a third input from the user to initiate locating of one or more dynamic UI elements. The element locating unit is configured to highlight two dynamic UI elements from the located one or more dynamic UI elements and receive a fourth input from the user for selecting one of the highlighted dynamic UI elements as a reference element and the second highlighted dynamic UI element as an expected element.

The element recording unit is configured to collect the located one or more static UI elements and the located one or more dynamic UI elements based on the second input, and the fourth input from the user. Further, the element recording unit is configured to display the collected static UI elements and dynamic UI elements to the user when requested by the user. The element recording unit is configured to allow the user to select one or more of the displayed static UI elements and dynamic UI elements to be recorded.

The element recording unit is configured to receive a fifth input from the user to select a license and a project under which the selected one or more static UI elements and dynamic UI elements are to be recorded. The element recording unit is configured to receive a sixth input from the user to record the selected one or more static UI elements and dynamic UI elements under the selected project. Further, the element recording unit is configured to receive a seventh input from the user to assign pages to which the selected one or more static UI elements and dynamic elements are to be recorded under the selected project.

Further, the element recording unit is configured to send the recorded one or more static UI elements and dynamic UI elements to a server. The server includes an element receiving unit, a test script creation unit and a test script execution unit. The element receiving unit is configured to receive the recorded one or more static UI elements and dynamic UI elements from the element recording unit and to store the received one or more static UI elements and dynamic UI elements in a server database. The test script creation unit is configured to allow the user to use the one or more static UI elements and dynamic UI elements stored in the database for creating one or more test scripts for a project. The test script execution unit is configured to execute the created one or more test scripts for the project.

The present disclosure further discloses a method for locating user interface (UI) elements in a web application and a mobile application using a unified element finder. The method includes receiving, by a user interface (UI) element finder, an input from a user to either select a web interface to locate one or more UI elements present in a web application or a mobile interface to locate one or more UI elements present in a mobile application, wherein the UI element finder comprises an element locating unit and an element recording unit.

The method includes receiving, by the element locating unit, a first input from the user to initiate locating of one or more static UI elements present on a web application or a mobile application based on the selected web interface or mobile interface. Further, the method includes highlighting, by the element locating unit, a located static UI element from the located one or more static UI elements. Also, the method includes receiving, by the element locating unit, a second input from the user to select the highlighted static UI element.

Further, the method includes receiving, by the element locating unit, a third input from the user to initiate locating of one or more dynamic UI elements. The method includes highlighting, by the element locating unit, two dynamic UI elements from the located one or more dynamic UI elements. Also, the method includes receiving, by the element locating unit, a fourth input from the user for selecting one of the highlighted dynamic UI elements as a reference element and the second highlighted dynamic UI element as an expected element.

Furthermore, the method includes collecting, by the element recording unit, the located one or more static UI elements and the located one or more dynamic UI elements based on the second input, and the fourth input from the user. The method includes displaying, by the element recording unit, the collected static UI elements and dynamic UI elements to the user when requested by the user. The method includes allowing, by the element recording unit, the user to select one or more of the displayed static UI elements and dynamic UI elements to be recorded.

Also, the method includes receiving, by the element recording unit, a fifth input from the user to select a license and a project under which the selected one or more static UI elements and dynamic UI elements are to be recorded. The method includes receiving, by the element recording unit, a sixth input from the user to record the selected one or more static UI elements and dynamic UI elements under the selected project.

### BRIEF DESCRIPTION OF DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates a system architecture 100 for locating user interface (UI) elements in a web application and a mobile application using a unified element finder, in accordance with an embodiment of the present disclosure.

FIG. 2 illustrates an architecture 200 of the user device 102 and the server 108 of FIG. 1, in accordance with an embodiment of the present disclosure.

FIG. 3 illustrates an exemplary user device 102 screen 300 illustrating a Web Interface 302 and a Mobile Interface 304, in accordance with an embodiment of the present disclosure.

FIGS. 4A-4D illustrate an exemplary user device 102 display screens for locating and recording UI web elements, in accordance with an embodiment of the present disclose.

FIGS. 5A-5C illustrate an exemplary user device 102 display screens for locating and recording UI mobile elements, in accordance with an embodiment of the present disclosure.

FIG. 6 illustrates a method 600 for locating user interface (UI) elements in a web application and a mobile application using a unified element finder, in accordance with an embodiment of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

It will be understood by those skilled in the art that the foregoing general description and the following detailed description are exemplary and explanatory of the invention and are not intended to be restrictive thereof.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting. The system, methods, and examples provided herein are only illustrative and not intended to be limiting.

Embodiments of the present invention will be described below in detail with reference to the accompanying figures.

The present invention focusses on providing a system and a method for locating user interface (UI) elements in a web application and a mobile application using a unified (single) element finder. Test automation is a practice of running various software tests automatically, managing test data automatically, and utilizing results to improve software quality. In other words, test automation is a process of using automation tools to execute a test case suite. A test suite is a collection of test cases or test steps grouped together for text execution purposes. Therefore, Test Automation is a process to maintain test data, execute tests, and analyze generated test results to improve software quality. When executed well, test automation runs various software tests automatically, thereby eliminating the practise of manual testing performed by a human sitting in front of a computer carefully executing the test steps. Test automation is used by Quality Assurance (QA) engineers in a number of applications, such as testing test scripts, testing web applications, testing mobile applications, creating object repositories, reusing objects stored in object repositories, etc.

To test web applications and mobile applications from an end-user's perspective, QAs have to interact with multiple user interface (UI) web and mobile elements. To do so, the QAs use an object repository while writing test automation scripts. In test automation, building UI web elements and UI mobile elements object repository through manual process is tedious task & requires skilled engineers. Also, hard-coding or manual coding locators or objects in a test script each time results in code duplication. Thus, if a value of any single coding locator or object changes, it needs to be updated throughout the project to ensure consistency, thereby making it a time-consuming task. Further, a separate element finder is required for locating UI web elements in a web application and a separate element finder for locating UI mobile elements in a mobile application. Therefore, maintaining individual element finders for web applications and mobile applications requires huge maintenance.

Therefore, the present invention discloses a system and a method for building user interface (UI) element repository automatically without any human intervention. Also, the present invention discloses a system and a method for locating UI web elements in a web application and UI mobile elements in a mobile application using a single element finder, thereby eliminating a need for a separate UI element finder for web applications and separate UI element finder for mobile applications. The present invention also discloses a system and a method for recording the located UI web elements and located UI mobile elements and allowing a user to use the recorded UI web elements and UI mobile elements in test scripts used in software testing.

FIG. 1 illustrates a system architecture 100 for locating user interface (UI) elements in a web application and a mobile application using a unified element finder, in accordance with an embodiment of the present disclosure. The system 100 includes a user device 102 monitored by a user 104a and a mobile device 106 monitored by a user 104b. The system 100 further includes a server 108 communicating with the user device 102 and the mobile device 106 over a communication network 110. It may be noted that the user 104a and the user 104b may be two different persons or a same person without departing from the scope of the invention. Therefore, herein after the user 104a and 104b are collectively referred to as user 104.

The user device 102 and the mobile device 106 relate to a hardware component such as a keyboard, keypad, mouse, etc which accepts data from the user 104 and also relates to a hardware component such as a display screen of a desktop, laptop, tablet, mobile phone, smart phone, etc. which displays data to the user 104. Examples of a user device 102 may include, but not limited to, a computer, a laptop, an interactive television, etc. Further, examples of mobile devices 106 may include, but not limited to, a tablet, a smart phone, a mobile phone, etc. The user device 102 is configured to provide an interface to the user 104 for locating user interface (UI) web elements from one or more web applications present on the user device 102, and record the located UI web elements, and to display the located UI web elements to the user 104. The one or more web applications may include, but not limited to, URL (Uniform Resource Locator) links in chrome, social media apps, shopping apps, gaming apps, etc.

Further, the user device 102 is configured to be connected to the mobile device 106 virtually so that UI mobile elements present in one or more mobile applications in the mobile device 106 may be located, recorded and displayed to the user 104 on the user device 102. The one or more mobile applications may include, but not limited to, gaming apps, social media apps, shopping apps, image gallery, video gallery, URL (Uniform Resource Locator) links in chrome, settings, play store, google maps, email apps, video conference apps, etc.

The user 104 may be, but not limited to, a quality assurance (QA) engineer, an automation engineer analysing a software, any employ of an organisation trained to analyze a software, or a third party capable of analyzing a software. The interface provided by the user device 102 to a user 104 may include, but not limited to, a graphical user interface (GUI), a command line interface (CLI), a menu-driven interface, a touch user interface, a voice user interface, a form-based user interface, or a natural language programming (NLP) interface.

The server 108 is configured to receive the located and recorded UI web elements and UI mobile elements from the user device 102 and to store the received UI web elements and UI mobile elements in a server database 112.

The communication network 110 may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. In an example, the network may include a mobile communication network, for example, 2G, 3G, 4G, or 5G mobile communication network. The communication network may be coupled to one or more other networks, thereby providing coupling between a greater number of devices. Such can be the case, for example, when networks are coupled together via the Internet.

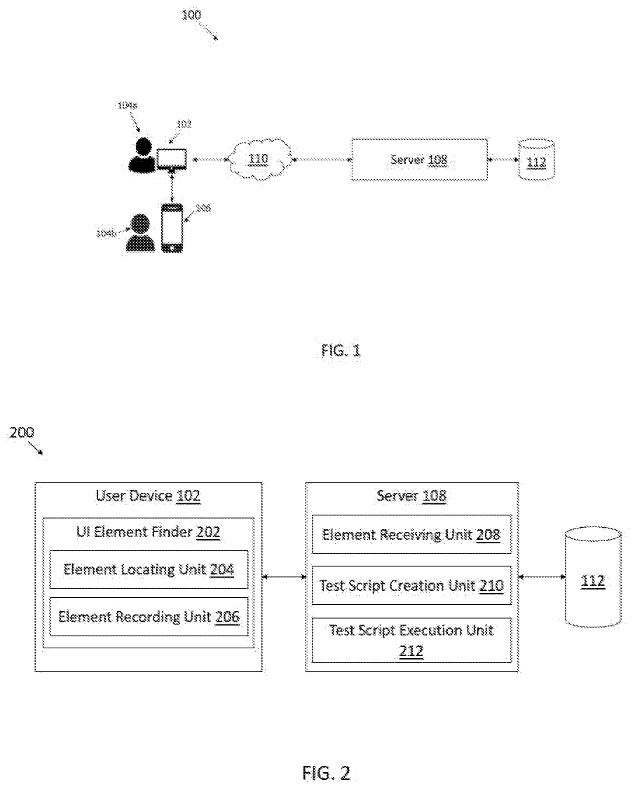

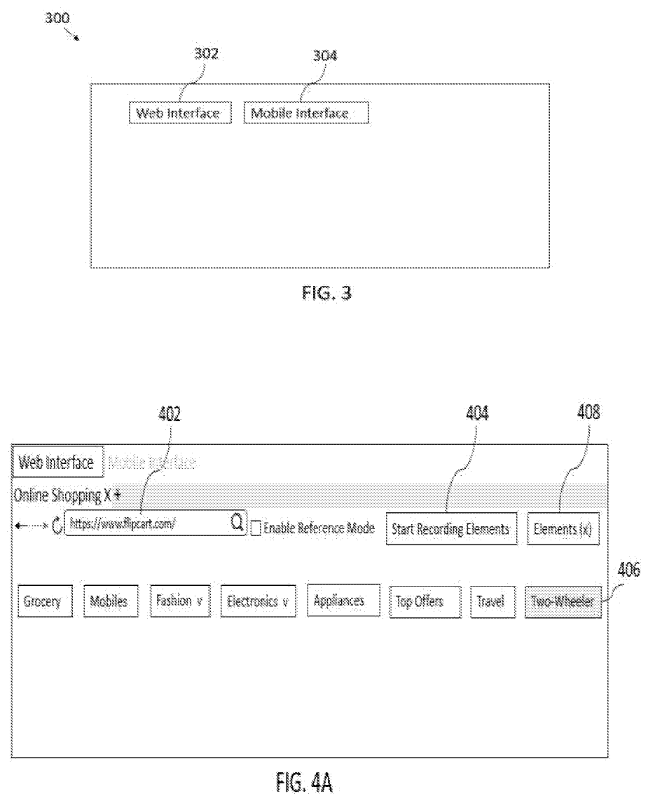

FIG. 2 illustrates an architecture 200 of the user device 102 and the server 108 of FIG. 1, in accordance with an embodiment of the present disclosure. The user device 102 includes a user interface (UI) element finder 202 installed on it by the user 104. Once installed, the UI element finder 202 allows the user 104 to either continue with a Web interface to locate UI web elements in a web application or a Mobile interface to locate UI mobile elements in a mobile application. FIG. 3 illustrates an exemplary user device 102 screen 300 illustrating a Web interface 302 and a Mobile interface 304, in accordance with an embodiment of the present disclosure. In an embodiment of the present disclosure, the Web interface 302 is selected automatically, without any input from the user 104. In another embodiment of the present disclosure, the user 104 may select the Web interface 302 manually.

In an embodiment of the present disclosure, when a Web interface is selected, the UI element finder 202 is configured to allow the user 104 to load an URL (uniform resource locator) of a web application for which one or more UI web elements are to be located. The UI element finder 202 includes an element locating unit 204 and an element recording unit 206. Once the URL of a web application has been loaded by the user 104, the element locating unit 204 is configured to receive a first input from the user 104 to initiate locating of one or more UI web elements present on the web application. In an embodiment of the present disclosure, the first input includes clicking on a “Start Recording Element” tab by the user 104.

The element locating unit 204 is configured to locate static UI web elements as well as dynamic UI web elements present on the web application. Static UI web elements are web elements which do not change their position on the web application even if the URL of the web application is loaded “N” number of times. Dynamic UI web elements are web elements which change their position and attributes (such as id (identity), name, class name) on the web application every time the URL of the web application is loaded.

On receiving the first input from the user 104, the element locating unit 204 is configured to locate one or more static UI web elements on the web application and highlights a located static UI web element from the located one or more static UI web elements for the user 104 on the user device 102. The element locating unit 204 is further configured to receive a second input from the user 104 to select the highlighted static UI web element. In an embodiment of the present disclosure, the second input includes “clicking” or “right clicking” the highlighted static UI web element by the user 104. In another embodiment of the present disclosure, the second input may include, but not limited to, pointing a cursor to the highlighted static UI web element by the user 104. In yet another embodiment of the present disclosure, the second input may include any selection means known. When the user 104 performs click or right click action on the highlighted static UI web element based on a html code, the element locating unit 204 is configured to capture locators of the highlighted static UI web elements. Further, for xpath and cssSelector as per the xpath and CssSelector syntax, the element locating unit 204 is configured to generate a xpath and CssSelectors. Along with the locators, the element locating unit 204 is configured to capture an element name, element type, attributes of that element and HTML code of the highlighted static UI web element.

The element locating unit 204 is further configured to receive a third input from the user 104 to initiate locating of one or more dynamic UI web elements on the web application. On receiving the third input from the user 104, the element locating unit 204 is configured to highlight two dynamic UI web elements from the located one or more dynamic UI web elements for the user 104 on the user device 102. In an embodiment of the present disclosure, the third input includes, but not limited to, selecting “Enable reference mode” checkbox on the web application by the user. When the user 104 selects “Enable reference element mode” checkbox, the element locating unit 204 is configured to locate one or more dynamic UI web elements in such a manner that even though location and any attribute of a dynamic UI web element gets change, a locator value of the dynamic UI web element will be still valid only. If the user does not select the “Enable reference mode” checkbox, then the element locating unit 204 is configured to locate static locators for the dynamic UI web element.

Thereafter, the element locating unit 204 is configured to receive a fourth input from the user 104 for selecting one of the highlighted dynamic UI web elements as a reference element and the second highlighted dynamic UI web element as an expected element by clicking or right clicking the highlighted dynamic UI web elements. This is repeated each time a dynamic UI web element is to be located. When the user 104 perform click or right click action on the highlighted dynamic UI web element based on a html code, the element locating unit 204 is configured to capture locators of the highlighted dynamic UI web elements. Further, for xpath and cssSelector as per the xpath and CssSelector syntax, the element locating unit 204 is configured to generate a xpath and CssSelectors. Along with the locators, the element locating unit 204 is configured to capture an element name, element type, attributes of that element and HTML code of the highlighted UI dynamic web element.

The element recording unit 206 is configured to collect the located one or more static UI web elements and the located one or more dynamic UI web elements based on the second input, and the fourth input from the user 104. The element recording unit 206 is further configured to keep a track of a count of the collected one or more static UI web elements and one or more dynamic UI web elements. The element recording unit 206 is also configured to display the collected static UI web elements and dynamic UI web elements to the user 104 when requested by the user 104. When requested by the user 104, the element recording unit 206 is configured to display to the user 104 all the collected static UI web elements and recorded dynamic UI web elements (collectively referred to as UI web elements) along with name of the UI web element recorded, type of the UI web element, and locators of a particular UI web element. In an embodiment of the present disclosure, the name, type and locators of the UI web element may be automatically displayed. In another embodiment of the present disclosure, the name, type and locators of the UI web element may be modified or selected by the user 104.

Thereafter, the element recording unit 206 is configured to allow the user 104 to select one or more of the displayed UI web elements and either remove the selected one or more UI web elements or move the one or more selected UI web elements for recording. When the user 104 selects “remove”, the selected one or more UI web elements are removed from the displayed UI web elements list. When the user 104 selects “move”, the element recording unit 206 is configured to receive an input from the user 104 to select a license from a list of licenses purchased by the user 104. After a license has been selected by the user 104, the element recording unit 206 is configured to receive an input from the user 104 to select a project under which the selected one or more UI web elements are to be recorded. The element recording unit 206 is also configured to receive an input from the user 104 to assign pages to which the selected one or more UI web elements are to be recorded. Pages are containers which are created in repository section under which the user 104 may store the selected UI web elements. The element recording unit 206 is further configured to receive an input from the user 104 to record the selected one or more UI web elements under the selected project and assigned pages. The element recording unit 206 is also configured to send the recorded UI web elements to the server 108.

In another embodiment of the present disclosure, when a Mobile interface is selected by the user 104, the UI element finder 202 is configured to allow the user 104 to select a mobile device 106 on the user device 102 so that the user 104 is able to control a display screen of the selected mobile device virtually from the display screen of the user device 102. Once a mobile device is selected, the user 104 is able to control the selected mobile device virtually and is able to view one or more mobile applications of the selected mobile device from the user device 102. The UI element finder 202 is further configured to allow the user 104 to select a mobile application from the mobile device 106 for locating one or more UI mobile elements (static and dynamic) present in the selected mobile application. Thereafter, the element locating unit 204 is configured to receive a first input from the user 104 to initiate locating of one or more UI mobile elements present on the mobile application. In an embodiment of the present disclosure, the first input includes clicking on a “Start Recording Element” tab by the user 104. The element locating unit 204 is configured to locate static UI mobile elements as well as dynamic UI mobile elements present on the mobile application. Static UI mobile elements are mobile elements which do not change their position on the mobile application even if the URL of the mobile application is loaded “N” number of times. Dynamic UI mobile elements are mobile elements which change their position and attributes (such as id (identity), name, class name) on the mobile application every time the URL of the mobile application is loaded.

On receiving the first input from the user 104, the element locating unit 204 is configured to initiate locating of one or more static UI mobile elements on the mobile application and highlighting a static UI mobile element from the located one or more static mobile elements for the user 104 on the user device 102. The element locating unit 204 is further configured to receive a second input from the user 104 to select the highlighted static UI mobile element. In an embodiment of the present disclosure, the second input includes “clicking” or “right clicking” the highlighted static UI mobile element by the user 104. In another embodiment of the present disclosure, the second input may include, but not limited to, pointing a cursor to the highlighted static UI mobile element by the user 104. In yet another embodiment of the present disclosure, the second input may include any selection means known.

When the user 104 performs click or right click action on the highlighted static UI dynamic element based on a html code, the element locating unit 204 is configured to capture locators of the highlighted static UI mobile elements. Further, for xpath and cssSelector as per the xpath and CssSelector syntax, the element locating unit 204 is configured to generate a xpath and CssSelectors. Along with the locators, the element locating unit 204 is configured to capture an element name, element type, attributes of that element and HTML code of highlighted static UI mobile element.

The element locating unit 204 is further configured to receive a third input from the user 104 to initiate locating of one or more dynamic UI mobile elements on the mobile application. On receiving the third input from the user 104, the element locating unit 204 is configured to highlight two dynamic UI mobile elements from the located one or more dynamic UI elements for the user 104 on the user device 102. In an embodiment of the present disclosure, the third input includes, but not limited to, selecting “Enable reference mode” checkbox on the mobile application by the user 104. When the user 104 selects “Enable reference element mode” checkbox, the element locating unit 204 is configured to locate the dynamic UI mobile elements in such a manner that even though location and any attribute of the dynamic UI mobile element gets change, a locator value of the dynamic UI mobile element will be still valid only. If the user does not select the “Enable reference mode” checkbox, then the element locating unit 204 is configured to locate static locators for the dynamic UI mobile element.

Thereafter, the element locating unit 204 is configured to receive a fourth input from the user 104 for selecting one of the highlighted dynamic UI mobile elements as a reference element and the second highlighted dynamic UI mobile element as an expected element by clicking or right clicking the highlighted dynamic UI mobile element. This is repeated each time a dynamic UI mobile element is to be located. When the user 104 perform click or right click action on the highlighted dynamic UI mobile element based on a html code, the element locating unit 204 is configured to capture locators of the highlighted dynamic UI mobile elements. Further, for xpath and cssSelector as per the xpath and CssSelector syntax, the element locating unit 204 is configured to generates a xpath and CssSelectors. Along with the locators, the element locating unit 204 is configured to capture an element name, element type, attributes of that element and HTML code of the highlighted dynamic UI mobile element.

The element recording unit 206 is configured to collect the located one or more static UI mobile elements and the located one or more dynamic UI mobile elements based on the second input, and the fourth input from the user 104. The element recording unit 206 is further configured to keep a track of a count of the collected static UI mobile elements and dynamic UI mobile elements. The element recording unit 206 is also configured to display the collected static UI mobile elements and dynamic UI mobile elements to the user 104 when requested by the user 104. When requested by the user 104, the element recording unit 206 is configured to display to the user 104 all the collected static UI mobile elements and dynamic UI mobile elements (collectively referred to as UI mobile elements) along with name of the UI mobile element recorded, type of the UI mobile element, and locators of a particular UI mobile element. In an embodiment of the present disclosure, the name, type and locators of the UI mobile element may be automatically displayed. In another embodiment of the present disclosure, the name, type and locators of the UI mobile element may be modified or selected by the user 104. Thereafter, the element recording unit 206 is configured to allow the user 104 to select one or more of the displayed UI mobile elements and either remove the selected one or more UI mobile elements or move the one or more selected UI mobile elements for recording. When the user 104 selects “remove”, the selected one or more UI mobile elements are removed from the displayed UI mobile elements list. When the user 104 selects “move”, the element recording unit 206 is configured to receive an input from the user 104 to select a license from a list of licenses purchased by the user 104. After a license has been selected by the user 104, the element recording unit 206 is configured to receive an input from the user 104 to select a project under which the selected one or more UI mobile elements are to be recorded. The element recording unit 206 is also configured to receive an input from the user 104 to assign pages to which the selected one or more UI mobile elements are to be recorded. Pages are containers which are created in repository section under which the user 104 may store the selected one or more UI mobile elements. The element recording unit 206 is further configured to receive an input from the user 104 to record the selected one or more UI mobile elements under the selected project and assigned pages. The element recording unit 206 is also configured to send the recorded UI mobile elements to the server 108. The server 108 includes an element receiving unit 208, a test script creation unit 210 and a test script execution unit 212. The element receiving unit 208 is configured to receive the recorded UI web elements (static UI web elements and dynamic UI web elements) from the element recording unit 206. The element receiving unit 208 is also configured to receive recorded UI mobile elements (static UI mobile elements and dynamic UI mobile elements) from the element recording unit 206. The element receiving unit 208 is further configured to store the received UI web elements and received UI mobile elements in the server database 112. In an embodiment, the element receiving unit 208 receives the recorded UI web elements and recorded UI mobile elements from the element recording unit 206 using an Application Programming Interface (API). In another embodiment, the element receiving unit 208 may receive the recorded UI web elements and recorded UI mobile elements from the element recording unit 206 using any communication technique known. The test script creation unit 210 is configured to allow the user 104 to use the UI web elements and UI mobile elements stored in the database 112 for creating one or more test scripts for a project. The test script execution unit 212 is configured to execute the created one or more test scripts for the project. The test script execution unit 212 may also be configured to store a result of the execution of the one or more test scripts of the project in the database 112.

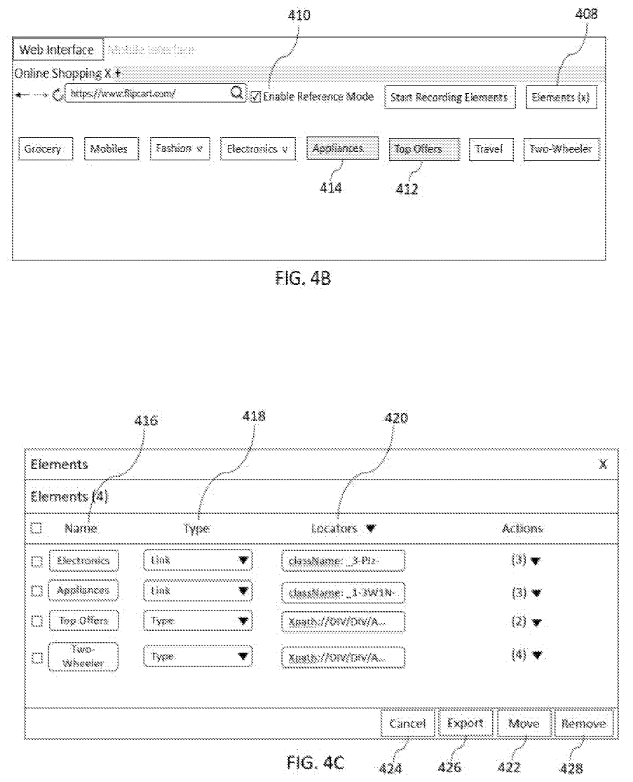

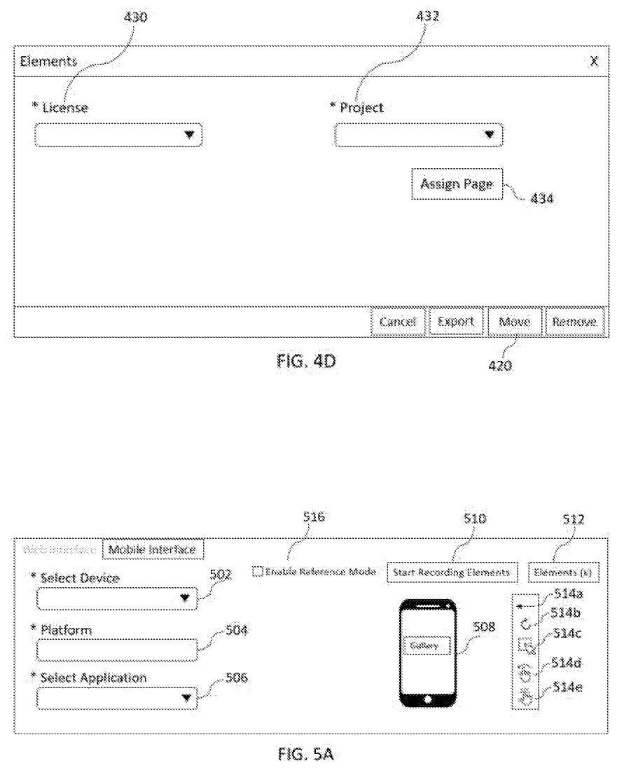

FIGS. 4A-4D illustrate an exemplary user device 102 display screens for locating and recording UI web elements, in accordance with an embodiment of the present disclose. When the user 104 selects the Web interface 302 (FIG. 3) or the Web interface 302 is automatically selected, the UI element finder 202 allows the user 104 to enter an URL of a web application from which the UI web elements (static UI web elements and dynamic UI web elements) are to be located and recorded.

FIG. 4A illustrates that the user 104 has entered a URL: https://www.flipkart.com 402. Once the entered URL is opened, the user 104 may select the option “Start Recording Elements” 404 to locate UI web elements. When the user 104 clicks on the option 404, the element locating unit 204 starts locating static UI web elements and highlights the located static UI web elements one by one. For example, as shown in FIG. 4A, the element locating unit 204 highlights a located static UI web element 406. The user 104 may then click or right click on the highlighted static UI web element to select the highlighted static UI web element. When the user 104 perform click or right click action on the highlighted static UI web element based on a html code, the element locating unit 204 captures locators of the highlighted static UI web elements. Further, for xpath and cssSelector as per the xpath and CssSelector syntax, the element locating unit 204 generates a xpath and CssSelectors. Along with the locators, the element locating unit 204 also captures an element name, element type, attributes of that element and HTML code of the highlighted static UI web element. Thereafter, the element recording unit 206 collects the selected static UI web element under the tab “Elements (x)” 408, where x is the number of UI web elements recorded. Further, in order to locate dynamic UI web elements, the user 104 may select the option “Enable reference mode” 410. FIG. 4B illustrates the option 410 selected by the user 104. When the user 104 selects the option 410, the element locating unit 204 highlights two of the located dynamic UI web elements 412 and 414. Thereafter, the user 104 selects one highlighted UI web element as a reference element (UI web element 412) and the other highlighted UI web element as an expected element (UI web element 414) by performing a click or right click action on the highlighted UI web element. When the user 104 perform click or right click action on the highlighted static UI web element based on a html code, the element locating unit 204 captures locators of the highlighted dynamic UI web elements. Further, for xpath and cssSelector as per the xpath and CssSelector syntax, the element locating unit 204 generates a xpath and CssSelectors. Along with the locators, the element locating unit 204 also captures an element name, element type, attributes of that element and HTML code of the highlighted dynamic UI web elements.

Once the reference element and the expected element have been selected by the user 104, the element recording unit collects the selected dynamic UI web elements under the tab “Elements (x)” 408, where x is the number of UI web elements recorded. The user 104 has to select a reference element and an expected element every time a dynamic UI web element is to be located and recorded. Once the UI web elements (static and dynamic) have been recorded, the element recording unit 206 may display the recorded UI web elements to the user 104 when the user selects the tab “Elements (x)” 408. FIG. 4C illustrates an exemplary user device 102 screen displaying the recorded UI web elements to the user 104. FIG. 4C illustrates that the user 104 is able to see name of the UI web element recorded 416, type of the UI web element 418, and locators of a particular UI web element 420. In an embodiment of the present disclosure, the type of the UI web element 418 may be automatically shown in which the UI web element type is captured based on a “type” attribute or with the help of a tagname. In another embodiment of the present disclosure, the type of the UI web element 418 may be modified or selected by the user 104 using a dropdown arrow next to the option “TYPE”. Further, when the user 104 wants to update the locators of a particular UI web element 420, the user 104 may click on the expandable icon beside a particular element and hover a pointer on a particular locator (xpath). Thereafter, the user 104 is able to view three options of edit, remove, copy (not shown), thereby allowing the user 104 to edit, remove or copy locators of a particular UI web element. The user 104 may also select one or more of the displayed UI web elements by selecting a checkbox besides name of a UI web element. When one or more UI web elements are selected by the user 104, a tab “Move” 422 is enabled to allow moving the selected one or more UI web elements for recording. The user 104 may also cancel the display screen or the selected UI web elements by clicking on a tab “Cancel” 424. The user 104 may also export the selected one or more UI web elements by clicking on tab “Export” 426 or remove the selected one or more UI web elements from the list of displayed UI web element by clicking on the tab “Remove” 428. When the user 104 clicks on the tab “Move” 422, the user 104 selects a license from a list of licenses bought by the user and a project. FIG. 4D illustrates that the user 104 may select a license under the license tab 430 by clicking on the dropdown arrow next to the license tab 430. On clicking the dropdown arrow, all the licenses bought by the user 104 are displayed, from which the user 104 may select one license. The user 104 also selects a project under the project tab 432 by clicking on the dropdown arrow next to the project tab 432. On clicking the dropdown arrow, all the projects are displayed to the user 104, from which the user 104 may select one project. The projects for UI web elements may include, but limited to, Web, Web & Mobile and Salesforce type projects.

The user may also assign pages by clicking the tab “Assign Page” 434 to which the recorded elements are to be moved and recorded. Pages are containers which are created in repository section under which the user 104 may store the UI web elements. The user 104 may then click on the tab “Move” 422 to move the selected one or more UI web elements to be recorded under the selected project and at the assigned pages.

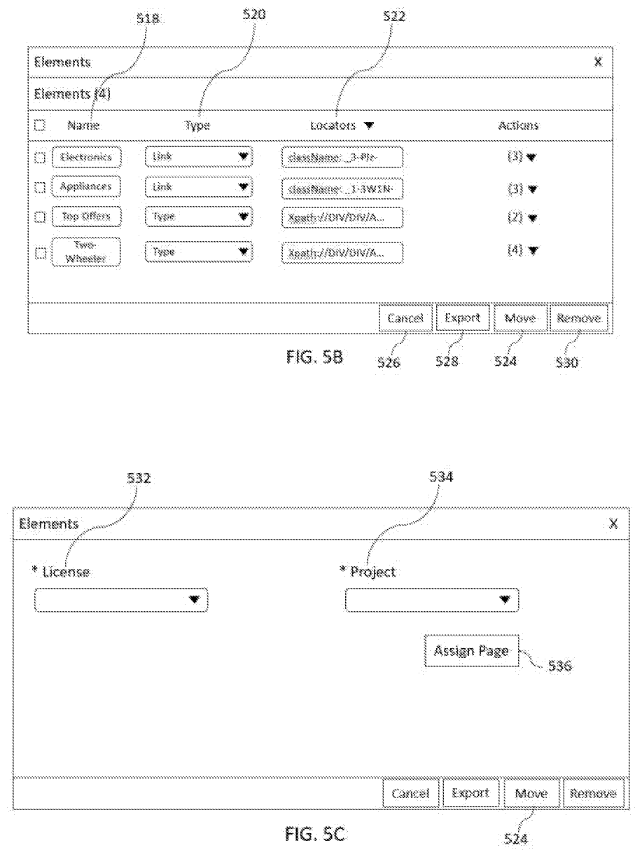

FIGS. 5A-5C illustrate an exemplary user device 102 display screens for locating and recording UI mobile elements, in accordance with an embodiment of the present disclosure. When the user 104 selects the Mobile interface 304 (FIG. 3), the UI element finder 202 allows the user 104 to select a mobile device 106 on the user device 102 by clicking dropdown arrow next to the tab “Select Device” 502 so that the user 104 is able to control a display screen of the selected mobile device virtually from the display screen of the user device 102. Once a mobile device is selected, the user 104 is able to control the selected mobile device virtually and is able to view one or more mobile applications of the selected mobile device from the user device 102. In an embodiment of the present disclosure, the user device 102 may connect to one mobile device. In another embodiment of the present disclosure, the user device 102 may connect to multiple mobile devices, each mobile device having multiple mobile applications.

When the user 104 selects a mobile device, an operating platform of the selected mobile device is displayed under the tab “Platform” 504. The operating platform of a mobile device may include, but not limited to, Android or iOS. The user 104 also selects a mobile application by clicking on the dropdown arrow next to the tab “Select Application” 506 to select a mobile application from the mobile device 106 for locating one or more UI mobile elements (static and dynamic) in the selected mobile application. When the user 104 clicks on the dropdown arrow next to the tab “Select Application” 506, all the mobile application present on the selected mobile device are displayed to the user 104 on the user device 102. The user 104 then selects one of the displayed mobile applications and the selected mobile application is displayed on a mobile device picture 508 present on the display screen of the user device 102. For example, if the user 104 selects gallery of the selected mobile device as a mobile application, the gallery is displayed on the mobile device picture 508.

Once the user 104 has selected a mobile device and a mobile application, the user 104 may then click on the tab “Start Recording Elements” 510 to locate UI mobile elements. When the user 104 clicks on the tab 510, the element locating unit 204 starts locating static UI mobile elements and highlights the located static UI mobile elements one by one. The user 104 may then click or right click on the highlighted static UI mobile element to select the highlighted static UI mobile element. When the user 104 perform click or right click action on the highlighted static UI mobile element based on a html code, the element locating unit 204 captures locators of the highlighted static UI mobile element. Further, for xpath and cssSelector as per the xpath and CssSelector syntax, the element locating unit 204 generates a xpath and CssSelectors. Along with the locators, the element locating unit 204 also captures an element name, element type, attributes of that element and HTML code of the highlighted static UI mobile element. Thereafter, the element recording unit 206 collects the selected static UI mobile element under the tab “Elements (x)” 512, where x is the number of UI web elements recorded.

FIG. 5A illustrates that the user 104 may also be able to perform multiple actions like “BACK” by selecting BACK icon 514a, “REFRESH” by selecting REFRESH icon 514b, “SELECT” by selecting SELECT icon 514c, “SWPIE” by selecting SWIPE icon 514d, and “TAP” by selecting TAP action 514e. When the user 104 selects BACK icon 514a, the user 104 is able to do a back action in the selected mobile device. When the user 104 select REFRESH icon 514b, the user 104 is able to refresh the display screen if the user 104 faces any screen issues in the virtual screen of the selected mobile device. When the user 104 selects SELECT icon 514c, the user 104 is able to hover a mouse on one or more mobile elements and capture the one or more mobile elements. When the user 104 selects SWIPE icon 514d, the user 104 is able to swipe the virtual screen. In order to so, the user 104 has to swipe by coordinates. For example: if the user 104 has to swipe up then the user 104 will have to tap the footer of the virtual screen and second tap on the header of the virtual screen. When the user 104 selects TAP icon 514e, the user 104 is able to tap any of the one or more mobile elements which are clickable to navigate to another display screen.

Further, in order to locate dynamic UI mobile elements, the user 104 may select the option “Enable reference mode” 516. When the user 104 selects the option 516, the element locating unit 204 highlights two of the located dynamic UI mobile elements. Thereafter, the user 104 selects one highlighted UI mobile element as a reference element and the other highlighted UI mobile element as an expected element by performing a click or right click action on the highlighted UI mobile element. When the user 104 perform click or right click action on the highlighted static UI mobile element based on a html code, the element locating unit 204 captures locators of the highlighted dynamic UI mobile elements. Further, for xpath and cssSelector as per the xpath and CssSelector syntax, the element locating unit 204 generates a xpath and CssSelectors. Along with the locators, the element locating unit 204 also captures an element name, element type, attributes of that element and HTML code of the highlighted dynamic UI web elements.

Once the reference element and the expected element have been selected by the user 104, the element recording unit collects the selected dynamic UI mobile element under the tab “Elements (x)” 512, where x is the number of UI mobile elements recorded. The user 104 has to select a reference element and an expected element every time a dynamic UI mobile element is to be located and recorded. Once the UI mobile elements (static and dynamic) have been recorded, the element recording unit 206 may display the recorded UI mobile elements to the user 104 when the user selects the tab “Elements (x) 512. FIG. 5B illustrates an exemplary user device 102 screen displaying the recorded UI mobile elements to the user 104. FIG. 5B illustrates that the user 104 is able to see name of the UI mobile element recorded 518, type of the UI mobile element 520, and locators of a particular UI mobile element 522. In an embodiment of the present disclosure, the type of the UI mobile element 520 may be automatically shown in which the UI mobile element type is captured based on a “type” attribute or with the help of a tagname. In another embodiment of the present disclosure, the type of the UI mobile element 520 may be modified or selected by the user 104 using a dropdown arrow next to the option “TYPE”.

Further, when the user 104 wants to update the locators of a particular UI mobile element 522, the user 104 may click on the expandable icon beside a particular UI mobile element and hover a pointer on a particular locator (xpath). Thereafter, the user 104 is able to view three options of edit, remove, copy (not shown), thereby allowing the user 104 to edit, remove or copy locators of a particular UI mobile element. The user 104 can also select one or more displayed UI mobile elements by selecting a checkbox besides name of a UI mobile element. When one or more UI mobile elements are selected by the user 104, a tab “Move” 524 is enabled to allow moving the selected one or more UI mobile elements for recording. The user 104 may also cancel the display screen or the selected UI mobile elements by clicking on a tab “Cancel” 526. The user 104 may also export the selected one or more UI mobile elements by clicking on tab “Export” 528 or remove the selected one or more UI mobile elements from the list of displayed UI mobile element by clicking on the tab “Remove” 530. When the user 104 clicks on the tab “Move” 524, the user 104 selects a license from a list of licenses bought by the user and a project. FIG. 5C illustrates that the user 104 may select a license under the license tab 532 by clicking on the dropdown arrow next to the license tab 532. On clicking the dropdown arrow, all the licenses bought by the user 104 are displayed, from which the user 104 may select one license. The user 104 also selects a project under the project tab 534 by clicking on the dropdown arrow next to the project tab 534. On clicking the dropdown arrow, all the projects are displayed to the user 104, from which the user 104 may select one project. The projects for UI mobile elements may include, but not limited to, Mobile, Web & Mobile and Salesforce type projects. The user may also assign pages by clicking the tab “Assign Page” 536 to which the recorded elements are to be moved. Pages are containers which are created in repository section under which the user 104 may store the UI mobile elements. The user 104 may then click on the tab “Move” 524 to move the selected one or more UI mobile elements to be recorded under the selected project and at the assigned pages.

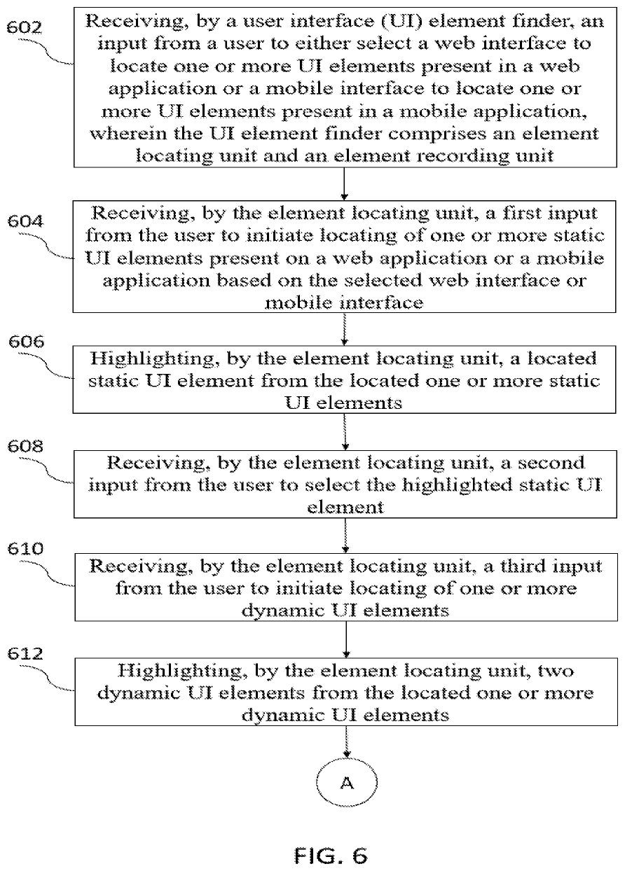

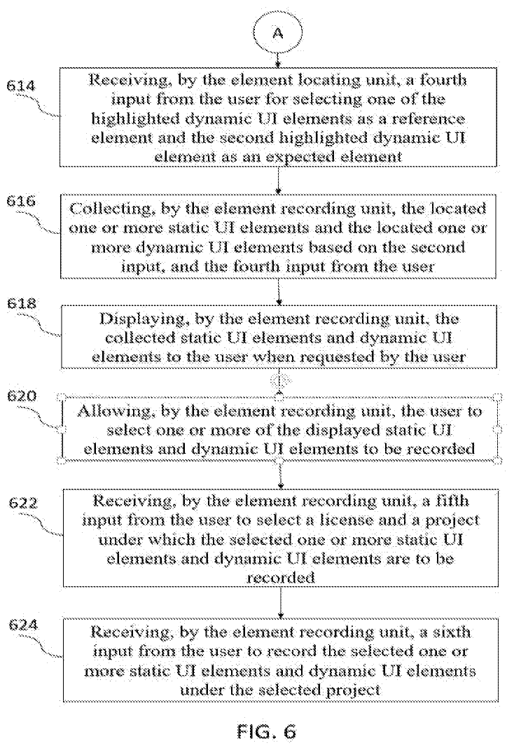

FIG. 6 illustrates a method 600 for locating user interface (UI) elements in a web application and a mobile application using a unified element finder, in accordance with an embodiment of the present disclosure. The step 602 includes receiving, by a user interface (UI) element finder 202, an input from a user 104 to either select a web interface to locate one or more UI elements present in a web application or a mobile interface to locate one or more UI elements in a mobile application, wherein the UI element finder 202 comprises an element locating unit 204 and an element recording unit 206.

The step 604 includes receiving, by the element locating unit 204, a first input from the user 104 to initiate locating of one or more static UI elements present on a web application or a mobile application based on the selected web interface or mobile interface. Further, the step 606 includes highlighting, by the element locating unit 204, a located static UI element from the located one or more static UI elements. The step 608 includes receiving, by the element locating unit 204, a second input from the user 104 to select the highlighted static UI element. The step 610 includes receiving, by the element locating unit 204, a third input from the user 104 to initiate locating of one or more dynamic UI elements. Further, the step 612 includes highlighting, by the element locating unit 204, two dynamic UI elements from the located one or more dynamic UI elements. The step 614 includes receiving, by the element locating unit 204, a fourth input from the user 104 for selecting one of the highlighted dynamic UI elements as a reference element and the second highlighted dynamic UI element as an expected element. The step 616 includes collecting, by the element recording unit 206, the located one or more static UI elements and the located one or more dynamic UI elements based on the second input, and the fourth input from the user 104. Further, the step 618 includes displaying, by the element recording unit 206, the collected static UI elements and dynamic UI elements to the user 104 when requested by the user 104. The step 620 includes allowing, by the element recording unit 206, the user 104 to select one or more of the displayed static UI elements and dynamic UI elements to be recorded.

The step 622 includes receiving, by the element recording unit 206, a fifth input from the user 104 to select a license and a project under which the selected one or more static UI elements and dynamic UI elements are to be recorded. The step 624 includes receiving, by the element recording unit 206, a sixth input from the user 104 to record the selected one or more static UI elements and dynamic UI elements under the selected project.

The system and method for automatically locating Web and Mobile UI elements disclosed in the present disclosure have numerous advantages. The system and method for automatically locating Web and Mobile UI elements disclosed in the present disclosure help in locating user interface (UI) elements in a web application and a mobile application using a unified (single) element finder, thereby eliminating a need for a separate element finder for web applications and separate element finder for mobile applications. The system and method for automatically locating Web and Mobile UI elements disclosed in the present disclosure provides a unified element finder to locate UI web elements in web applications and UI mobile elements in mobile applications with all possible locator values required for Test Automation.

The system and method for automatically locating Web and Mobile UI elements disclosed in the present disclosure help in recording the located UI web elements and located UI mobile elements and allowing a user to use the recorded UI web elements and UI mobile elements in creating test scripts used in software testing. The system and method for automatically locating Web and Mobile UI elements disclosed in the present disclosure help in building a UI element repository automatically without any human intervention.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

I/We claim:

1. A system (100) for locating user interface (UI) elements in a web application and a mobile application using a unified element finder comprising:
a user interface (UI) element finder (202) configured to receive an input from a user (104) to either select a web interface to locate one or more UI elements present in a web application or a mobile interface to locate one or more UI elements present in a mobile application, wherein the UI element finder (202) comprises:
an element locating unit (204) configured to:
receive a first input from the user (104) to initiate locating of one or more static UI elements present on a web application or a mobile application based on the selected web interface or mobile interface;
highlight a located static UI element from the located one or more static UI elements;
receive a second input from the user (104) to select the highlighted static UI element;
receive a third input from the user (104) to initiate locating of one or more dynamic UI elements;
highlight two dynamic UI elements from the located one or more dynamic UI elements; and
receive a fourth input from the user (104) for selecting one of the highlighted dynamic UI elements as a reference element and the second highlighted dynamic UI element as an expected element; and
an element recording unit (206) configured to:
collect the located one or more static UI elements and the located one or more dynamic UI elements based on the second input, and the fourth input from the user (104);
display the collected static UI elements and dynamic UI elements to the user (104) when requested by the user (104);
allow the user (104) to select one or more of the displayed static UI elements and dynamic UI elements to be recorded;
receive a fifth input from the user (104) to select a license and a project under which the selected one or more static UI elements and dynamic UI elements are to be recorded; and
receive a sixth input from the user (104) to record the selected one or more static UI elements and dynamic UI elements under the selected project.

2. The system (100) as claimed in claim 1, wherein a web interface is selected automatically without any input from the user (104).

3. The system (100) as claimed in claim 1, wherein the one or more UI elements comprise one or more UI web elements present in a web application when a web interface is selected.

4. The system (100) as claimed in claim 3, wherein when a web interface is selected by the user (104), the UI element finder (202) is configured to allow the user (104) to load an URL (uniform resource locator) of a web application for which one or more UI web elements are to be located.

5. The system (100) as claimed in claim 1, wherein the one or more UI elements comprise one or more UI mobile elements present in a mobile application when a mobile interface is selected.

6. The system (100) as claimed in claim 5, when a mobile interface is selected by the user (104), the UI element finder (202) is configured to allow the user (104) to connect to a mobile device from a user device (102) so that the user (104) is able to view display of the mobile device screen virtually on a display screen of the user device (102) to locate one or more UI mobile elements present in a mobile application of the mobile device.

7. The system (100) as claimed in claim 1, wherein the element locating unit (204) is configured to capture name, type, attributes, HTML (Hyper Text Markup Language) code and locators of the highlighted static UI element based on the second input from the user (104) and to generate a xpath and CssSelectors for the captured locators.

8. The system (100) as claimed in claim 1, wherein the element locating unit (204) is configured to capture name, type, attributes, HTML (Hyper Text Markup Language) code and locators of the highlighted dynamic UI elements based on the fourth input for the user (104) and to generate a xpath and CssSelectors for the captured locators.

9. The system (100) as claimed in claim 1, wherein the element recording unit (206) is configured to keep a track of a count of the collected UI web elements.

10. The system (100) as claimed in claim 1, wherein the element recording unit (206) is configured to receive a seventh input from the user (104) to assign pages to which the selected one or more UI elements are to be recorded under the selected project.

11. The system (100) as claimed in claim 1, wherein the element recording unit (206) is configured to send the recorded one or more static UI elements and dynamic UI elements to a server (108).

12. The system (100) as claimed in claim 11, wherein the server (108) comprises:
an element receiving unit (208) configured to receive the recorded one or more static UI elements and dynamic UI elements from the element recording unit (206) and to store the received one or more static UI elements and dynamic UI elements in a server database (112);
a test script creation unit (210) configured to allow the user (104) to use the one or more static UI elements and dynamic UI elements stored in the database (112) for creating one or more test scripts for a project; and
a test script execution unit (212) configured to execute the created one or more test scripts for the project.

13. The system (100) as claimed in claim 12, wherein the element receiving unit (208) is configured to receive the recorded one or more static UI elements and dynamic UI elements from the element recording unit (206) using an Application Programming Interface (API).

14. A method (600) for locating user interface (UI) elements in a web application and a mobile application using a unified element finder, the method comprising:
receiving, by a user interface (UI) element finder (202), an input from a user (104) to either select a web interface to locate one or more UI elements present in a web application or a mobile interface to locate one or more UI elements present in a mobile application, wherein the UI element finder (202) comprises an element locating unit (204) and an element recording unit (206);
receiving, by the element locating unit (204), a first input from the user (104) to initiate locating of one or more static UI elements present on a web application or a mobile application based on the selected web interface or mobile interface;
highlighting, by the element locating unit (204), a located static UI element from the located one or more static UI elements;
receiving, by the element locating unit (204), a second input from the user (104) to select the highlighted static UI element;
receiving, by the element locating unit (204), a third input from the user (104) to initiate locating of one or more dynamic UI elements;
highlighting, by the element locating unit (204), two dynamic UI elements from the located one or more dynamic UI elements;
receiving, by the element locating unit (204), a fourth input from the user (104) for selecting one of the highlighted dynamic UI elements as a reference element and the second highlighted dynamic UI element as an expected element;
collecting, by the element recording unit (206), the located one or more static UI elements and the located one or more dynamic UI elements based on the second input, and the fourth input from the user (104);
displaying, by the element recording unit (206), the collected static UI elements and dynamic UI elements to the user (104) when requested by the user (104);
allowing, by the element recording unit (206), the user (104) to select one or more of the displayed static UI elements and dynamic UI elements to be recorded;
receiving, by the element recording unit (206), a fifth input from the user (104) to select a license and a project under which the selected one or more static UI elements and dynamic UI elements are to be recorded; and
receiving, by the element recording unit (206), a sixth input from the user (104) to record the selected one or more static UI elements and dynamic UI elements under the selected project.

15. The method (600) as claimed in claim 14, wherein the method comprises allowing, by the UI element finder (202), the user (104) to load an URL (uniform resource locator) of a web application for which one or more UI elements are to be located when a web interface is selected by the user (104).

16. The method (600) as claimed in claim 14, wherein the method comprises allowing, by the UI element finder (202), the user (104) to connect to a mobile device from a user device (102) so that the user (104) is able to view display of the mobile device screen virtually on a display screen of the user device (102) to locate one or more UI mobile elements present in a mobile application of the mobile device when a mobile interface is selected by the user (104).

17. The method (600) as claimed in claim 14, wherein the method comprises capturing, by the element locating unit (204), name, type, attributes, HTML (Hyper Text Markup Language) code and locators of the highlighted static UI element based on the second input from the user (104) and generating, by the element locating unit (204), a xpath and CssSelectors for the captured locators.

18. The method (600) as claimed in claim 14, wherein the method comprises capturing, by the element locating unit (204), name, type, attributes, HTML (Hyper Text Markup Language) code and locators of the highted dynamic UI elements based on the fourth input for the user (104) and generating, by the element locating unit (204) a xpath and CssSelectors for the captured locators.

19. The method (600) as claimed in claim 14, wherein the method comprises receiving, by the element recording unit (206), a seventh input from the user (104) to assign pages to which the selected one or more UI elements are to be recorded under the selected project.

20. The method (600) as claimed in claim 14, wherein the method comprises sending, by the element recording unit (206), the recorded one or more static UI elements and dynamic UI elements to a server (108), wherein the server (108) is configured to store the received one or more static UI elements and dynamic UI elements in a server database (112).
